(19) United States
(12) Patent Application Publication
(10) Pub. No.: US 2020/0263430 A1
(43) Pub. Date: Aug. 20, 2020

(54) ROOFING MATERIALS AND METHODS ASSOCIATED THEREWITH

(71) Applicant: Saint-Gobain Ceramics & Plastics, Inc, P. O. Box 15008, MA (US)

(72) Inventors: Francesca Mirri, Marlborough, MA (US); Michael Patrick McGahan, 35 Kane Lane, RI (US); Ian Kidd, Worcester, MA (US)

(21) Appl. No.: 16/778,382

(22) Filed: Jan. 31, 2020

Related U.S. Application Data
(60) Provisional application No. 62/806,189, filed on Feb. 15, 2019.

(51) Int. Cl. E04D 1/26; E04D 1/16; E04D 1/20

(52) U.S. Cl. CPC E04D 1/26; E04D 2001/005; E04D 1/20; E04D 1/16

(57) ABSTRACT

A method of forming a roofing granule comprising: subtractively forming bauxite into particles having a size ranging from 300 microns to 2500 microns; sintering the particles; and applying a geopolymer material to the particles. A roofing granule comprising: a bauxite substrate having a non-homogenous stratum; and a geopolymer-based ceramic coating disposed around the bauxite substrate.

### CROSS-REFERENCE TO RELATED APPLICATION

This application claims the benefit of U.S. Provisional Application No. 62/806,172 filed Feb. 15, 2019.

### FIELD OF THE DISCLOSURE

The present disclosure relates to roofing materials, and more particularly to roofing granules with high solar reflectivity.

### RELATED ART

Roofing materials, such as shingles, are typically formed from a base substrate with particles disposed thereon to provide desired roofing characteristics. Traditionally, sought after roofing characteristics pertained to color, texture, and visual appearance.

Most current substrates include asphalt or bitumen layers coated with rock, such as feldspar. While these shingles can provide sufficient functionality to cover buildings, they are not satisfactory for achieving solar reflectance currently demanded by the construction and housing industries.

### BRIEF DESCRIPTION OF THE DRAWINGS

Embodiments are illustrated by way of example and are not intended to be limited in the accompanying figures.

FIG. 1 includes a flow chart of a method of forming a roofing granule in accordance with an embodiment.

FIG. 2 includes a flow chart of forming a roofing granule in accordance with another embodiment.

FIG. 3 includes a cross-sectional view of an exemplary roofing granule in accordance with an embodiment.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The terms “generally,” “substantially,” “approximately,” and the like are intended to cover a range of deviations from the given value. In a particular embodiment, the terms “generally,” “substantially,” “approximately,” and the like refer to deviations in either direction of the value within 10% of the value, within 9% of the value, within 8% of the value, within 7% of the value, within 6% of the value, within 5% of the value, within 4% of the value, within 3% of the value, within 2% of the value, or within 1% of the value.

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the roofing and roofing granule arts.

In accordance with an aspect described herein, a roofing granule can include a bauxite substrate and a geopolymer-based ceramic coating disposed around the bauxite substrate. The bauxite substrate can have a non-homogenous stratum. In an embodiment, the granule can have a particle size in a range of 300 microns and 2500 microns. In another embodiment, the granule can have a coloration darker than the coloration of the bauxite substrate. The granule can have a solar reflectivity (SR) of at least 20%, at least 22%, at least 25%, or at least 27.5%. As used herein, “solar reflectivity” means the quantity measured by ASTM C1549 with a solar spectrum reflectometer (model SSR-ER available from Devices and Services Inc., Dallas, Tex.). In particular, solar reflectivity can refer to reflectance in the near infrared range (700 to 2500 nanometers) and visible range (400 to 700 nanometers) of the electromagnetic spectrum.

In an embodiment, the geopolymer-based ceramic coating can include a plurality of geopolymer-based ceramic coated layers. For instance, the geopolymer-based ceramic coating can include at least two layers, at least three layers, or at least four layers. In an embodiment, the plurality of geopolymer-based ceramic coated layers can include a first layer and a second layer. The first layer can be disposed between the bauxite substrate and the second layer. The first and second layers can include different colorations, different compositions, different characteristic attributes, or any combination thereof. In a particular embodiment, the first and second layers can have different colorations, opaqueness values, or both. In yet a more particular embodiment, the first layer can be clearer than the second layer. In yet another more particular embodiment, the first layer can be essentially free of pigment and the second layer can be pigmented. In certain instances, the pigment in the second layer can have an L* value adapted to maintain the L* color value of the coated particle less than 40, less than 35, less than 33, less than 32, or less than 31.

In an embodiment, the bauxite substrate can define a plurality of pores. The pores can be filled, or substantially filled, with the first layer of geopolymer-based ceramic coating. In a particular embodiment, the pores can be essentially free, or entirely free, of the second layer of geopolymer-based ceramic coating.

In certain instances, the geopolymer-based ceramic coating can be adapted to maintain a desired coloration for at least 5 years, at least 10 years, at least 15 years, at least 20 years, or at least 50 years as measured by rapid rating and freeze/thaw tests.

A roofing shingle can include a substrate defining an upper surface, and a plurality of granules disposed on the upper surface thereof. At least a portion of the granules can include those granules previously described herein. The roofing shingle can be adapted to be used with steep sloped roofs (e.g., residential roofing), with low sloped roofs (e.g., residential roofing), or both.

In another aspect described herein, a method of forming a roofing granule can include subtractively forming bauxite ore into particles having a size ranging from 300 microns to 2500 microns. In an embodiment, subtractive formation of the bauxite into particles can be performed by mechanically breaking bauxite ore. In a more particular embodiment, subtractive formation can be performed by crushing the bauxite ore, such as jaw crushing the ore, impact crushing the ore, roll crushing the ore, or any combination thereof.

In a particular embodiment, subtractively forming bauxite into particles can include a multistage process. The bauxite ore can first be crushed into intermediary particles having a size ranging from 2000 microns to 4000 microns. The intermediary particles can then be further crushed into shaped particles having a size ranging from 300 microns to 2500 microns. In certain instances, crushing bauxite ore into intermediary particles can be performed by a first crushing method and crushing the intermediary particles into shaped particles can be performed by a second method different than the first crushing method. By way of example, crushing bauxite ore can be performed by jaw crushing while crushing intermediary particles into shaped particles can be performed by roll crushing, impact crushing, or both.

The method can further include sintering the particles. In an embodiment, sintering can be performed at a temperature of at least 1000° C., at least 1100° C., or at least 1200° C. In another embodiment, sintering the particles can be performed at a temperature no greater than 1700° C., no greater than 1600° C., or no greater than 1500° C.

The method can further include applying a geopolymer material to the particles. In certain instances, the geopolymer material can include one or more pigments. The coated particle can have an L* color value less than 35, less than 34, less than 33, less than 32, or less than 31.

In an embodiment, sintering the particles can be performed prior to applying the geopolymer material to the particles. By way of non-limiting example, the geopolymer material can be applied by a coating process, such as bulk drum coating, spray coating, another suitable coating process, or any combination thereof. After application of the geopolymer material, the particles can be calcined. In an embodiment, calcination can be performed at a temperature of at least 400° C., at least 500° C., or at least 600° C. In another embodiment, calcination can be performed at a temperature no greater than 1200° C., no greater than 1000° C., or no greater than 800° C. Calcination of the geopolymer layer can create a ceramic coating along the outer surface of the bauxite particle.

In an embodiment, the method can further include applying an intermediate material to the particle. The intermediate material can be different than the previously described geopolymer material. In an embodiment, the intermediate material can include a geopolymer material. In a more particular embodiment, the intermediate material can include a substantially similar geopolymer to the previously described geopolymer material. In another more particular embodiment, the intermediate material can be essentially free of the geopolymer previously described with respect to the geopolymer layer. In certain instances, the intermediate material can be essentially free, or free, of pigment.

The intermediate material can be applied to the particles using a coating process, such as bulk drum coating, spray coating, another suitable coating process, or any combination thereof. In certain instances, the geopolymer material is applied using a first application method and the intermediate material is applied using a second application method different than the first application method.

After application of the intermediate material, the particles can be calcined. In an embodiment, calcination can be performed at a temperature of at least 400° C., at least 500° C., or at least 600° C. In another embodiment, calcination can be performed at a temperature no greater than 1200° C., no greater than 1000° C., or no greater than 800° C.

In an embodiment, the bauxite particles can be sintered prior to applying the intermediate material to the particles.

FIG. 1 includes a flow chart of a method 100 of forming a roofing granule in accordance with an embodiment. The method 100 can include subtractively forming 102 bauxite ore into particles, sintering 104 the particles, and applying 106 a geopolymer material to the particles.

In certain instances, the bauxite ore can have an iron content less than 10%, less than 8%, less than 6%, less than 5%, less than 4%, or less than 3%. In another instance, the bauxite ore can have an aluminum content greater than 50%, greater than 55%, greater than 60%, greater than 65%, or greater than 70%. In an embodiment, the bauxite ore can be at least partially refined prior to subtractively forming 102 the particles.

In an embodiment, the bauxite ore can be subtractively formed 102 into particles by mechanically breaking the bauxite ore using one or more hand tools, powered tools, or both. Exemplary subtractive formation processes include crushing, machining, ablating, and chemically removing. In a particular embodiment, the bauxite ore can be crushed into particles by jaw crushing, impact crushing, roll crushing, or any combination thereof.

In an embodiment, the bauxite ore can be subtractively formed 102 into particles using a multistage process. By way of non-limiting example, the bauxite ore can be subtractively formed 102 into intermediary particles having sizes ranging from 2000 microns to 4000 microns and again subtractively formed from the intermediary particles into shaped particles having sizes ranging from 300 microns to 2500 microns. In certain instances, the intermediary particles can have a unimodal size distribution between 2000 microns and 4000 microns. In other instances, the intermediary particles can have a multimodal size distribution between 2000 microns and 4000 microns. In yet another instance, the intermediary particles can have a non-modal size distribution ranging between 2000 microns and 4000 microns. That is, for instance, the intermediary particle size can be essentially free of discrete modal distribution. In an embodiment, the shaped particles can have a unimodal size distribution between 300 microns and 2500 microns. In another embodiment, the shaped particles can have a multimodal size distribution between 300 microns and 2500 microns. In yet a further embodiment, the shaped particles can have a non-modal size distribution ranging between 300 microns and 2500 microns.

In an embodiment, subtractively forming 102 the bauxite ore into intermediary particles can be performed by a first reductive method and subtractively forming the intermediary particles can be performed by a second reductive method different than the first reductive method. In a more particular embodiment, subtractively forming the bauxite ore into intermediary particles can be performed by a first crushing method and subtractively forming the intermediary particles can be performed by a second crushing method different than the first crushing method. By way of non-limiting example, crushing the bauxite ore into intermediary particles can be performed by jaw crushing. By way of another non-limiting example, crushing the intermediary particles into the shaped particles can be performed by roll crushing, impact crushing, or both.

It is noted that subtractively forming 102 bauxite ore into particles can be performed by reductive processes, none of which include the formation of one or more green-bodies using additive formation processes. In certain instances, subtractively forming 102 the shaped particles from the intermediary particles can include a subtractive shaping process to obtain specific-shaped particles. In another instance, subtractively forming 102 the shaped particles from the intermediary particles can refer only to a particle size-reducing process.

After formation, the particles can be sintered 104 at a temperature of at least 1000° C., at least 1100° C., or at least 1200° C. In another embodiment, the particles can be sintered 104 at a temperature no greater than 1700° C., no greater than 1600° C., or no greater than 1500° C. In certain instances, sintering 104 can be performed in a range of temperatures between 1200° C. and 1450° C. In an embodiment, sintering temperature can depend on application of the roofing granule. For instance, low-sloped roofs—like those found in commercial applications, often require higher solar reflectivity as compared to steep-sloped roofs—like those found in residential applications. For low-sloped applications, the particles can be sintered 104 at a relatively lower temperature, e.g., in a range of 1150° C. and 1250° C. For steep-sloped applications, the particles can be sintered at a relatively higher temperature, e.g., in a range of 1400° C. and 1500° C. The resulting particles for low-sloped applications can have lighter coloration as compared to the particles used for steep-sloped applications.

A geopolymer material can be applied 106 to the sintered particles. In a more particular embodiment, the geopolymer material can be applied 106 after sintering 104 is complete.

The geopolymer material can include, for instance, an alumina, silicate, or aluminosilicate in combination with an alkaline medium such as, for example, potassium, sodium, lithium, or calcium. Further exemplary alkaline mediums include potassium silicate and sodium silicate, and lime solution. In an embodiment, the mechanical properties, curing time, and curing temperature can be affected by the alumina to silica ratio in the geopolymer material.

In an embodiment, the geopolymer material can include a pigment or a plurality of pigments. In a particular instance, the pigment can be selected from an inorganic pigment, including for instance, one or more metal oxides. Exemplary compositions include, but are not limited to, chrome iron nickel spinel, cobalt aluminate, iron chromite, chrome hematite, blends, zinc iron chromite, sodium alumino sulphosilicates, manganese ferrite spinels, copper chromite spinels, cobalt titinate spinels, copper phthalocyanine blue, manganese antimony titanium ritule, iron oxide, carbon black, graphite, carbon nanotubes, titania, zinc oxide, and alumina. Pigments can be red, yellow, green, blue, brown, white, black, or any combination thereof. By way of example, the pigment can darken the color of the sintered particles. In certain instances, the coated particles can have an L* color value, as measured using the 1976 CIE L*a*b* color space, less than 40, less than 38, or less than 35. In a more particular embodiment, the L* color value is less than 33, less than 32, or less than 31. Use of pigment in the geopolymer material may be particularly useful for steep-sloped applications (e.g., residential applications).

In an embodiment, the geopolymer material can be applied 106 by coating the geopolymer material onto the particle. In a more particular embodiment, the geopolymer material can be applied 106 by additively coating the geopolymer material onto the particle in a non-submersion process, such as by spray coating. In a particular instance, the particle can be coated with the geopolymer material through a single-layered, spray coating. In an embodiment, the spray coating can be formed from a solution or slurry sprayed under pressure. In a particular embodiment, at least one of the particles and spray gun is in motion during spraying. In a more particular embodiment, the particles can be in motion during the coating process. This can help to limit agglomeration. In an embodiment, coating can occur at a temperature of at least 50° C., at least 75° C., at least 100° C., at least 150° C., or at least 200° C. In another non-limiting embodiment, the particle can be coated with a fluidized bed, pug mill with spray capability, drum coater with a spray lance, spray coat in a rotary kiln, or through a combination thereof.

After application 106 of the geopolymer material, the particle can be calcined 108. Calcination 108 can be performed by heating the coated particle to a temperature below the melting point and sintering point of the materials to bring about thermal decomposition, phase transition, or removal of a volatile fraction. Calcination 108 can dry excess moisture from the particle and solidify the geopolymer into a ceramic. In an embodiment, calcination 108 can be performed at a temperature of at least 400° C., at least 500° C., or at least 600° C. In another embodiment, calcination 108 can be performed at a temperature no greater than 1200° C., no greater than 1000° C., or no greater than 800° C. After calcination 108, particles for use in steep-sloped applications can exhibit a solar reflectivity of at least 20%, at least 22%, at least 25%, or at least 27.5%. Meanwhile, calcined 108 particles for use in low-sloped applications can exhibit solar reflectively of at least 70%, at least 75%, or at least 800/0.

The calcined particles can be combined 110 with a roofing substrate to form a roofing shingle or form. For example, bituminous roofing sheets are well known and can include a reinforcing web of fibrous material impregnated with a bituminous material. The calcined particles can be applied to the upper surface of the bituminous roofing sheet material and adhered therewith. In certain applications, the calcined particles can be pressed into the upper surface of the bituminous roofing sheet in order to be securely embedded therein. In other applications, the calcined particles can be adhered to the bituminous roofing sheet by an adhesive or other coupling agent.

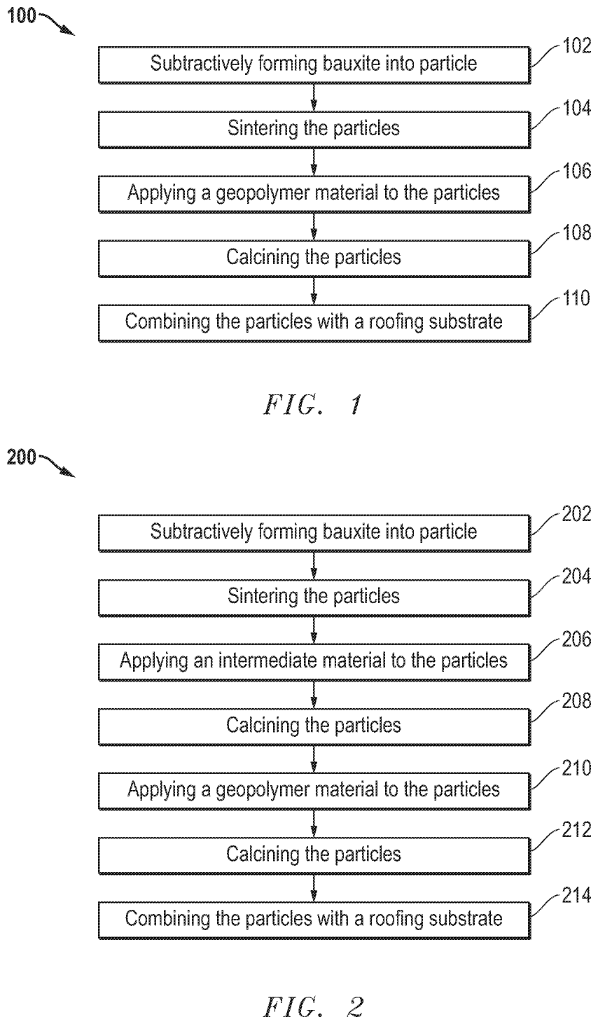

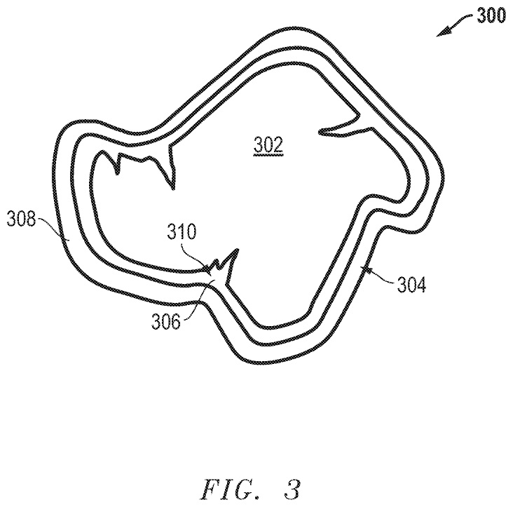

FIG. 2 includes a flow chart of a method 200 of forming a roofing granule in accordance with another embodiment. The method 200 can include any one or more steps as described with respect to method 100. For instance, the method 200 can include subtractively forming 202 bauxite ore into particles, sintering 204 the particles, and applying 210 geopolymer material to the particles.

Subtractive formation 202 of the bauxite ore into particles can be performed similar to the subtractive formation 102 described above. For instance, the bauxite ore can be subtractively formed 202 into particles by mechanically breaking the bauxite ore using one or more hand tools, powered tools, or both. Exemplary subtractive formation processes can include crushing, machining, ablating, and other subtractive formation processes. In a particular embodiment, the bauxite ore can be crushed into particles by jaw crushing, impact crushing, roll crushing, or any combination thereof.

In an embodiment, the bauxite ore can be subtractively formed 202 into particles using a multistage process. By way of non-limiting example, the bauxite ore can be subtractively formed 202 from raw ore into intermediary particles having sizes ranging from 2000 microns to 4000 microns and again subtractively formed into shaped particles having sizes ranging from 300 microns to 2500 microns. In certain instances, the intermediary particles can have a unimodal size distribution between 2000 microns and 4000 microns. In other instances, the intermediary particles can have a multimodal size distribution between 2000 microns and 4000 microns. In yet another instance, the intermediary particles can have a non-modal size distribution ranging between 2000 microns and 4000 microns. In an embodiment, the shaped particles can have a unimodal size distribution between 300 microns and 2500 microns. In another embodiment, the shaped particles can have a multimodal size distribution between 300 microns and 2500 microns. In yet a further embodiment, the shaped particles can have a non-modal size distribution ranging between 300 microns and 2500 microns.

In an embodiment, subtractive formation 202 of the bauxite ore into intermediary particles can be performed by a first reductive method subtractive formation 202 of the intermediary particles can be performed by a second reductive method different than the first reductive method. In a more particular embodiment, subtractively forming the bauxite ore into intermediary particles can be performed by a first crushing method and subtractively forming the intermediary particles can be performed by a second crushing method different than the first crushing method. By way of non-limiting example, crushing the bauxite ore into intermediary particles can be performed by jaw crushing. By way of another non-limiting example, crushing the intermediary particles into the shaped particles can be performed by roll crushing, impact crushing, or both.

Sintering 204 of the bauxite ore into particles can be performed similar to the sintering 104 process described above. For instance, after formation, the particles can be sintered 204 at a temperature of at least 1000° C., at least 1100° C., or at least 1200° C. In another embodiment, the particles can be sintered 204 at a temperature no greater than 1700° C., no greater than 1600° C., or no greater than 1500° C. In certain instances, sintering 204 can be performed in a range of temperatures between 1200° C. and 1450° C. In an embodiment, sintering temperature can depend on application of the roofing granule. For instance, low-sloped roofs—like those found in commercial applications, typically white in color, often require higher solar reflectivity as compared to steep-sloped roofs —like those found in residential applications. For low-sloped applications, the bauxite particles can be sintered 204 at a relatively lower temperature, e.g., in a range of 1150° C. and 1250° C. to maintain higher solar reflectivity. For steep-sloped applications, the bauxite particles can be sintered at a relatively higher temperature, e.g., in a range of 1400 C and 1500 C to improve coating quality. The resulting particles for low-sloped applications can have lighter coloration as compared to the particles used for steep-sloped applications.

The method 200 can further include applying 206 an intermediate material to the particles. The intermediate material can be applied 206 to the particle after sintering 204. In an embodiment, the intermediate material can be applied 206 using a coating process, such as bulk drum coating.

In certain instances, the intermediate material can include a geopolymer-based material. In other instances, the intermediate material can include non-geopolymer-based materials. In an embodiment, the intermediate material is similar, or the same, as the geopolymer material (similar, or the same, as the previously geopolymer described or the geopolymer described hereinafter). In another embodiment, the intermediate material is different than the geopolymer material. For instance, the intermediate material can be essentially free, or free, of pigment.

The particles can define an average first porosity, Φ₁, as measured, for example by mercury porosimetry, before applying the intermediate material, and an average second porosity, Φ₂, as measured before applying the geopolymer material, different than Φ₂. In an embodiment, Φ₁ can be greater than Φ₂. “Average porosity,” as used herein, refers to a volumetric ratio of empty space contained within a defined volume. As measured with respect to the average second porosity, ψ₂, “empty space” refers to volume free of bauxite particle material and intermediate material. In an embodiment, the particles can define a first specific surface area, SA₁, as measured before applying the intermediate material, and a second surface area, SA₂, as measured before applying the geopolymer material, wherein SA₁ can be different than SA₂. In a more particular embodiment, SA₁ can be greater than SA₂.

The particle can be calcined 208 after application 206 of the intermediate material. Calcination 208 can be performed by heating the coated particle to a temperature below the melting point and sintering point of the materials to bring about thermal decomposition, phase transition, or removal of a volatile fraction. Calcination 208 can dry excess moisture from the particle and solidify the geopolymer into a ceramic. In an embodiment, calcination 208 can be performed at a temperature of at least 400° C., at least 500° C., or at least 600° C. In another embodiment, calcination 208 can be performed at a temperature no greater than 1200° C., no greater than 1000° C., or no greater than 800° C.

A geopolymer material can be applied 210 to the calcined particles. In a more particular embodiment, the geopolymer material can be applied 210 after calcination 208 is complete.

The geopolymer material can include any one or more of the materials described with respect to method 100. For instance, in a particular embodiment, the geopolymer material can include an alumina, silicate, or aluminosilicate in combination with an alkaline medium such as potassium, sodium, lithium, calcium, or a combination thereof.

In an embodiment, the geopolymer material can include a pigment or a plurality of pigments. By way of example, the pigment can darken the color of the sintered particles. In certain instances, the coated particles can have an L* color value less than 40, less than 38, or less than 35. In a more particular embodiment, the L* color value is less than 33, less than 32, or less than 31. Use of pigment in the geopolymer material may be particularly useful for steep-sloped applications (e.g., residential applications).

In an embodiment, the geopolymer material can be applied 210 by coating the geopolymer material onto the particle. In a more particular embodiment, the geopolymer material can be applied 210 by additively coating the geopolymer material onto the particle in a submersion process, such as bulk drum coating.

After application 210 of the geopolymer material, the particle can be calcined 212. In an embodiment, calcination 212 can be different than calcination 208. For instance, calcination 212 can occur at a different temperature, for a different time duration, or both. In another embodiment, calcination 212 can include a similar calcination process as compared to calcination 208. For instance, calcination 212 can be performed at a temperature of at least 400° C., at least 500° C., or at least 600° C. In another embodiment, calcination 212 can be performed at a temperature no greater than 1200° C., no greater than 1000° C., or no greater than 800° C. After calcination 212, particles for use in steep-sloped applications can exhibit a solar reflectivity of at least 20%, at least 22%, at least 25%, or at least 27.5%. Meanwhile, calcined 108 particles for use in low-sloped applications can exhibit solar reflectively of at least 70%, at least 75%, or at least 80%.

The calcined particles can be combined 214 with a roofing substrate to form a roofing shingle or form. For example, bituminous roofing sheets are well known and can include a reinforcing web of fibrous material impregnated with a bituminous material. The calcined particles can be applied to the upper surface of the bituminous roofing sheet material and adhered therewith. In certain applications, the calcined particles can be pressed into the upper surface of the bituminous roofing sheet in order to be securely embedded therein. In other applications, the calcined particles can be adhered to the bituminous roofing sheet by an adhesive or other coupling agent.

Referring to FIG. 3, a roofing granule 300 can include a bauxite substrate 302 and a geopolymer-based ceramic coating 304 disposed around the bauxite substrate 302. In an embodiment, the bauxite substrate 302 can have a non-homogenous stratum. By way of example, non-homogenous stratum can occur when subtractively forming particles from ore. Naturally occurring stratum can be formed from the naturally occurring stratum within the ore. To the contrary, additive processes like green-body formation typically results in homogenous, or substantially homogenous, composition as ground powder is compacted and fused together to equally distribute previous stratum throughout the particle.

The bauxite substrate 302 can be formed by reductive manufacturing processes, such as crushing previously described. In an embodiment, the roofing granule 300 can have a coloration darker than the coloration of the bauxite substrate 302 (e.g., residential applications). In another embodiment, the roofing granule 300 can have a coloration that is the same or lighter than the coloration of the bauxite substrate 302 (e.g., commercial applications).

In an embodiment, the geopolymer-based ceramic coating 304 includes a single layer. In another embodiment, the geopolymer-based ceramic coating 304 includes a plurality of geopolymer-based layers, including, for instance, a first layer 306 and a second layer 308. In certain instances, the first and second layers 306 and 308 can comprise different colorations. For instance, at least one of the first and second layers 306 or 308 can include a pigment, and the other of the first and second layers 306 and 308 can be essentially free of pigment. The coated particle can have an L* color value less than 40, less than 35, less than 33, less than 32, or less than 31.

In an embodiment, the bauxite substrate 302 can define a plurality of pores 310 (which may take the form of recesses, voids, abscesses, pockets, or other concavities) filled, or substantially filled, with the first layer 306 and essentially free of the second layer 308.

In certain instances, roofing granules and shingles in accordance with one or more embodiments described herein can be adapted to reflect solar heat. For example, granules and shingles adapted for low-sloped applications can be adapted to have a solar reflectance (SR) of at least 70%, at least 75%, or at least 80%. Granule and shingles for steep-sloped applications can be adapted to have SR of at least 20%, at least 22.5%, at least 25%, or at least 27.5%. The granules can be adapted to maintain desired coloration for at least 5 years, at least 10 years, at least 15 years, at least 20 years, or at least 50 years.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiment 1

A method of forming a roofing granule comprising:
subtractively forming bauxite into particles having a size ranging from 300 microns to 2500 microns;
sintering the particles; and
applying a geopolymer material to the particles.

### Embodiment 2

The method of embodiment 1, wherein the geopolymer material comprises pigment.

### Embodiment 3

The method of embodiment 2, wherein the coated particles comprise an L* color value less than 35, less than 34, less than 33, less than 32, or less than 31.

### Embodiment 4

The method of any one of the preceding embodiments, further comprising applying an intermediate material to the particles.

### Embodiment 5

The method of embodiment 4, wherein the intermediate material is different than the geopolymer material.

### Embodiment 6

The method of any one of embodiments 4 and 5, wherein the intermediate material is essentially free of pigment.

### Embodiment 7

The method of any one of embodiments 4-6, wherein the intermediate material comprises a geopolymer.

### Embodiment 8

The method of any one of embodiments 4-7, wherein sintering the particles is performed prior to applying the intermediate material to the particles.

### Embodiment 9

The method of any one of embodiments 4-8, wherein the particles have an average first porosity, Φ₁, as measured before applying the intermediate material, and an average second porosity, Φ₂, as measured before applying the geopolymer material, and wherein Φ₁ is greater than Φ₂.

### Embodiment 10

The method of any one of embodiments 4-9, wherein the particles have a first specific surface area, SA₁, as measured before applying the intermediate material, and a second surface area, SA₂, as measured before applying the geopolymer material, and wherein SA₁ is greater than SA₂.

### Embodiment 11

The method of any one of embodiments 4-10, wherein applying the intermediate material to the particles is performed by a bulk drum coating process.

### Embodiment 12

The method of any one of the preceding, wherein applying the geopolymer material to the particles is performed by bulk drum coating, spray coating, or both.

### Embodiment 13

The method of any one of embodiments 4-12, wherein applying the geopolymer material is performed by a first application method, and wherein applying the intermediate material is performed by a second application method different than the first application method.

### Embodiment 14

The method of any one of embodiments 4-13, further comprising calcining the particle after applying the intermediate material to the particle.

### Embodiment 15

The method of embodiment 14, wherein calcining is performed at a temperature of at least 400° C., at least 500° C., or at least 600° C.

### Embodiment 16

The method of any one of embodiments 14 and 15, wherein calcining is performed at a temperature no greater than 1200° C., no greater than 1000° C., or no greater than 800° C.

### Embodiment 17

The method of any one of the preceding embodiments, wherein subtractively forming bauxite into particles is performed by mechanically breaking bauxite ore into particles.

### Embodiment 18

The method of any one of the preceding embodiments, wherein subtractively forming bauxite into particles is performed by crushing bauxite ore.

### Embodiment 19

The method of embodiment 18, wherein crushing bauxite ore comprises jaw crushing, impact crushing, roll crushing, or any combination thereof.

### Embodiment 20

The method of any one of the preceding embodiments, wherein subtractively forming bauxite into particles comprises:
crushing bauxite ore into intermediary particles having a size ranging from 2000 microns to 4000 microns; and
further crushing the intermediary particles into shaped particles having a size ranging from 300 microns to 2500 microns.

### Embodiment 21

The method of embodiment 20, wherein crushing bauxite ore into intermediary particles is performed by a first crushing method, and wherein crushing intermediary particles into shaped particles is performed by a second crushing method different than the first crushing method.

### Embodiment 22

The method of any one of embodiments 20 and 21, wherein crushing bauxite ore is performed by jaw crushing, and wherein crushing intermediary particles is performed by roll crushing, impact crushing, or both.

### Embodiment 23

The method of any one of the preceding embodiments, wherein sintering the particles is performed at a temperature of at least 1000° C., at least 1100° C., or at least 1200° C.

### Embodiment 24

The method of any one of the preceding embodiments, wherein sintering the particles is performed at a temperature no greater than 1700° C., no greater than 1600° C., or no greater than 1500° C.

### Embodiment 25

The method of any one of the preceding embodiments, wherein sintering is performed prior to applying the geopolymer layer to the particles.

### Embodiment 26

The method of any one of the preceding embodiments, further comprising calcining the particle after applying the geopolymer material.

### Embodiment 27

The method of embodiment 26, wherein calcining is performed at a temperature of at least 400° C., at least 500° C., or at least 600° C.

### Embodiment 28

The method of any one of embodiments 26 and 27, wherein calcining is performed at a temperature no greater than 1200° C., no greater than 1000° C., or no greater than 800° C.

### Embodiment 29

The method of any one of embodiments 26-28, wherein the calcined particles have a solar reflectivity (SR) of at least 20%, at least 22%, at least 25%, or at least 27.5%.

### Embodiment 30

A roofing granule comprising:
a bauxite substrate having a non-homogenous stratum; and
a geopolymer-based ceramic coating disposed around the bauxite substrate.

### Embodiment 31

The roofing granule of embodiment 30, wherein the granule has a particle size in a range of 300 microns and 2500 microns.

### Embodiment 32

The roofing granule of any one of embodiments 30 and 31, wherein the granule has a coloration darker than the coloration of the bauxite substrate.

### Embodiment 33

The roofing granule of any one of embodiments 30-32, wherein the granule has a solar reflectivity (SR) of at least 20%, at least 22%, at least 25%, or at least 27.5%.

### Embodiment 34

The roofing granule of any one of embodiments 30-33, wherein the geopolymer-based ceramic coating comprises a plurality of geopolymer-based layers.

### Embodiment 35

The roofing granule of embodiment 34, wherein the plurality of geopolymer-based layers comprises a first layer and a second layer.

### Embodiment 36

The roofing granule of embodiment 35, wherein the first and second layers comprise different colorations.

### Embodiment 37

The roofing granule of any one of embodiments 35 and 36, wherein the at least one of the plurality of geopolymer-based layers comprises a pigment, and at least one of the plurality of geopolymer-based layers is essentially free of pigment.

### Embodiment 38

The roofing granule of embodiment 37, wherein the coated particle has an L* value less than 40, less than 35, less than 33, less than 32, or less than 31.

### Embodiment 39

The roofing granule of any one of embodiments 35-38, wherein the bauxite substrate has a plurality of pores, and wherein the plurality of pores are filled with the first layer and essentially free of the second layer.

### Embodiment 40

The roofing granule of any one of embodiments 30-39, wherein the geopolymer-based ceramic coating is adapted to maintain desired coloration for at least 5 years, at least 10 years, at least 15 years, at least 20 years, or at least 50 years.

### Embodiment 41

A roofing shingle comprising:
a substrate defining an upper surface;
a plurality of granules disposed on the upper surface of the substrate, the granules comprising:
   a bauxite substrate having a non-homogenous stratum; and
   a geopolymer-based ceramic coating disposed around the bauxite substrate.

### Embodiment 42

The roofing shingle of embodiment 41, wherein the roofing shingle has a solar reflectivity (SR) of at least 20%, at least 22%, at least 25%, or at least 27.5%.

The roofing shingle of any one of embodiments 41 and 42, wherein the roofing shingle is adapted to be used with steep sloped roofs, low sloped roofs, or both.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. A method of forming a roofing granule comprising:
subtractively forming bauxite into particles having a size ranging from 300 microns to 2500 microns,
sintering the particles; and
applying a geopolymer material to the particles.

2. The method of claim 1, wherein the geopolymer material comprises pigment.

3. The method of claim 2, wherein the coated particles comprise an L* color value less than 35.

4. The method of claim 1, further comprising applying an intermediate material to the particles.

5. The method of claim 4, wherein the intermediate material is different than the geopolymer material.

6. The method of any one of claim 4, wherein the intermediate material is essentially free of pigment.

7. The method of claim 4, wherein the intermediate material comprises a geopolymer.

8. The method of any one of claims 4-9, wherein the particles have a first specific surface area, SA₁, as measured before applying the intermediate material, and a second surface area, SA₂, as measured before applying the geopolymer material, and wherein SA₁ is greater than SA₂.

9. The method of claim 1, wherein subtractively forming bauxite into particles comprises:
crushing bauxite ore into intermediary particles having a size ranging from 2000 microns to 4000 microns; and
further crushing the intermediary particles into shaped particles having a size ranging from 300 microns to 2500 microns.

10. The method of claim 9, wherein crushing bauxite ore into intermediary particles is performed by a first crushing method, and wherein crushing intermediary particles into shaped particles is performed by a second crushing method different than the first crushing method.

11. The method of any one of the preceding claims, wherein sintering the particles is performed at a temperature of at least 1000° C.

12. The method of any one of claims 26-28, wherein the calcined particles have a solar reflectivity (SR) of at least 20%.

13. A roofing granule comprising:
a bauxite substrate having a non-homogenous stratum; and
a geopolymer-based ceramic coating disposed around the bauxite substrate.

14. The roofing granule of claim 13, wherein the granule has a particle size in a range of 300 microns and 2500 microns.

15. The roofing granule of any one of claims 30-32, wherein the granule has a solar reflectivity (SR) of at least 20%, at least 22%, at least 25%, or at least 27.5%.

16. The roofing granule of claim 13, wherein the geopolymer-based ceramic coating comprises a plurality of geopolymer-based layers.

17. The roofing granule of claim 37, wherein the coated particle has an L* value less than 40.

18. The roofing granule of claim 35, wherein the bauxite substrate has a plurality of pores, and wherein the plurality of pores are filled with the first layer and essentially free of the second layer.

19. A roofing shingle comprising:
a substrate defining an upper surface;
a plurality of granules disposed on the upper surface of the substrate, the granules comprising:
a bauxite substrate having a non-homogenous stratum; and
a geopolymer-based ceramic coating disposed around the bauxite substrate.

20. The roofing shingle of claim 19, wherein the roofing shingle has a solar reflectivity (SR) of at least 20%.
